(19) United States
(12) Patent Application Publication
(10) Pub. No.: US 2009/0299792 A1
(43) Pub. Date: Dec. 3, 2009

(54) Cargo management system having integrated work order functions for cargo management

(76) Inventors: Andrea C. Baur, Stillwater, MN (US); Anthony F. Robertson, Hanger Lane (GB)

Correspondence Address: Charles A. Johnson;Unisys Corporation, MS 4773, P O Box 64942, St. Paul, MN, 55164, US

(21) Appl. No.: 10/830,724

(22) Filed: Apr. 23, 2004

Related U.S. Application Data
(60) Provisional application No. 60/510,290, filed on Oct. 10, 2003.

(51) Int. Cl. G06Q 10/00

(52) U.S. Cl. 705/8

(57) ABSTRACT

A cargo management system is described that includes a host computer system operating software that performs work order management tasks to maintain data associated with a work order. A user interface module presents a user interface for access to the host computer system. The user interface includes at least one input mechanism for specifying within the work order transfer of one or more goods undergoing a process to a destination location as specified by the work order. In one embodiment, the destination location includes one of a terminal container, a terminal location, a warehouse, and a unit load device. Based on the input mechanism, the host computer system links data associated with the one or more goods to the data associated with the work order, thereby adding the one or more goods to the work order. The one or more goods undergoing one or more processes may include goods in transit, goods still pending and goods undergoing unloading.

This application claims priority to U.S. provisional application Ser. No. 60/510,290, filed Oct. 10, 2003, the entire content of which is incorporated herein by reference.

### TECHNICAL FIELD

The invention generally relates to cargo management systems for tracking and managing shipments.

### BACKGROUND

One application of logistics management is the management of freight shipments. This process can be complex, and often requires coordination of multiple participants, including freight forwarders, carriers, warehouse staff, station managers and the like. In addition, the process often requires some form of shipment tracking, capacity control of flights, container control, terminal management, cash management, consolidation, and other common freight management tasks. One particularly complex area of cargo management is the planning and coordination involved in packing goods into “unit load devices” (ULDs), which are containers that hold freight for transport.

In many environments, a manager of a warehouse may simply inform warehouse personnel of which items are to be loaded into which containers. These instructions may be given in the form of written instruction, but often are simply given verbally.

This informal mechanism for planning and carrying out the loading of containers and performance of other warehouse management tasks leads to inherent inefficiencies. For example, it is often difficult to achieve any level of prioritization within the warehouse. In addition, this informal mechanism may be susceptible to human error. Moreover, this technique provides no central record of work that is scheduled to be carried out by warehouse personnel during a predetermined time period.

To assist with this complex process, cargo management systems have been developed that include basic cargo management features. These systems, however, have often been very inflexible. For example, these systems often require a planner to specify a particular identification number for each ULD used in the work plan. As the planner is not typically located within the warehouse, this may be difficult. Moreover, these systems are inflexible and consider only the loading of freight that is already physically present within the warehouse.

### SUMMARY

In general, the invention is directed to techniques for network-based management of “work orders” for directing warehouse personnel. More specifically, a cargo management system is described that presents a user-interface with which authorized users of the system interact to create, update and cancel work orders. The work orders presented by the user interface may incorporate a number of locations and goods undergoing many processes. Exemplary locations include but are not limited to station locations outside of the airport, such as dangerous materials areas, X-Ray areas, terminals and warehouses, wherein one or more containers may exist at each location. Exemplary goods undergoing processes include goods currently being unloaded from these containers, i.e., breakdown, goods currently in transit to the station, and goods still pending due to insufficient information, dangerous materials, inability by third parties to pickup and the like. As a result, the cargo management system allows work orders to be defined as general-purpose planning vehicles for the station office to provide action plans for a warehouse. Exemplary work orders may provide action plans for unit load device (ULD) build up, terminal container, e.g., dolly cart, flight build up, quick transfer pick lists, security controlled booking lists, broker delivery collection lists, interline pick lists and the like.

In accordance with the techniques described herein, the cargo management system provides integrated cargo management and work order generation, and allows integrated management of all aspects of a warehouse work order. These aspects may include management of individual work orders, booked goods, flight information, container information, terminal information, station information and the like. A user may remotely access the network-based system and create work orders detailing these various aspects from a location within a network, such as a station office. The user may not have complete knowledge of the various aspects, leaving the work orders flexible to the conditions in which the work orders are executed. For instance, a user viewing a created work order to execute the details of the work order may update the work order in the event goods scheduled to arrive do not arrive. Work orders of this flexible nature may provide for efficient management through cooperation by the manager and the executing staff.

The cargo management system may in addition schedule work orders well in advance of the arrival of the goods. Due to the flexible nature, the cargo management system may allow a user to alter the work order avoiding the creation of a new work order. Moreover the cargo management system may incorporate other shipment management features to provide additional services pertinent to shipment management task.

In one embodiment, the invention is directed to a method comprising presenting a user interface for a computer that provides work order management tasks, and processing the input mechanism received from the user interface to generate an electronic work order.

In another embodiment, the invention is directed to a cargo management system that comprises a host computer system operating software that performs work order management tasks to maintain data associated with a work order, and a user interface module that presents a user interface for access to the host computer system.

In another embodiment, the invention is directed to a cargo management system comprising a work order data storage means for storing data associated with a work order, wherein the data associated with a work order specifies a destination location, a goods data storage means for storing data associated with one or more goods undergoing one or more processes, and a computing means for linking the data associated with one or more goods to the data associated with the work order.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an exemplary network-based environment for managing work orders.

FIG. 2 is a block diagram illustrating an exemplary embodiment of a cargo management system

FIG. 3 illustrates an example user interface presented by a user interface module for managing work orders.

FIG. 4 illustrates an exemplary user interface to display detailed work order information.

FIG. 5 illustrates an exemplary user interface to perform the addition of booked shipments to a work order.

FIG. 6 illustrates an exemplary user interface to perform the addition of goods to a work order grouped by their offload station.

FIG. 7 illustrates exemplary user interface to perform the addition of booked or accepted shipments to a work order grouped by a given flight.

FIG. 8 illustrates an exemplary user interface to perform the addition of goods to a work order grouped by current warehouse location.

FIG. 9 illustrates an exemplary user interface to perform the addition of goods to a work order that are pending import processing.

FIG. 10 illustrates an exemplary user interface to perform the addition of goods to a work order that are arriving on an inbound flight to a station.

FIG. 11 illustrates an exemplary user interface to perform the addition of goods to a work order that are undergoing a breakdown process.

FIG. 12 illustrates an exemplary user interface to perform the update of a work order for a particular air waybill.

FIG. 13 is a flowchart illustrating example operation of a host computer system to manage the addition of goods to a work order.

### DETAILED DESCRIPTION

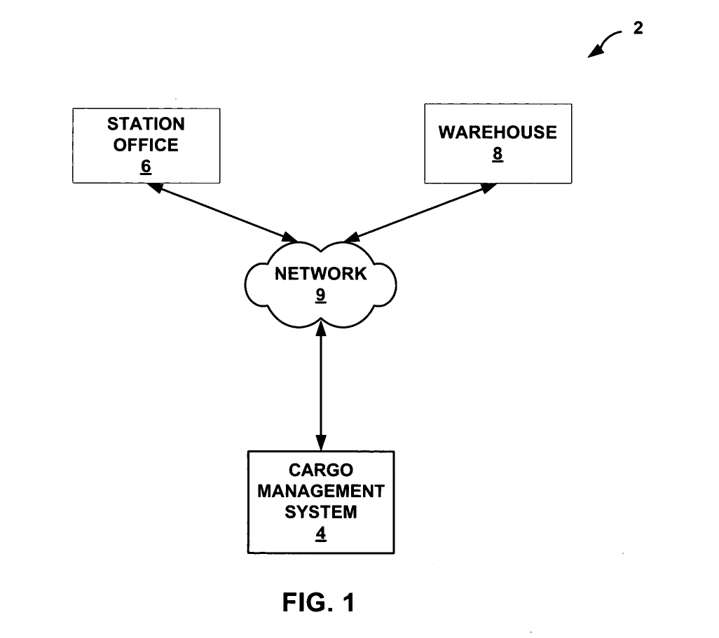

FIG. 1 is a block diagram illustrating an exemplary network based environment 2 in which cargo management system 4 provides network-based management of freight shipments. In particular, cargo management system 4 provides a network-based management of work orders. In general, work orders may be viewed as planning vehicles for scheduling and managing the movement of goods. For example, work orders may be used by a station office to provide action plans for warehouse personnel. Other exemplary work orders may provide action plans for unit load device (ULD) buildup, terminal container buildup, dolly cart buildup, flight buildup, quick transfer pick lists, security controlled booking lists, broker delivery collection lists, interline pick lists, and the like.

In one embodiment, work orders are used to plan and manage goods being transported by aircraft, such as commercial airliners. Work orders may also be used to arrange and track the movement of goods via any other transportation mechanism. For example, work orders may be used when moving goods over land via truck, train, light rail, bus, or any other land vehicle. Alternatively, work orders may be used to ship goods over water using any type of watercraft. Additionally, work orders may be used to plan movement of goods using a combination of the foregoing mechanisms. Work orders may even be used to plan movement of goods from one location in a building or building complex to another location in the same building or complex. In this latter embodiment, goods may be moved using a forklift, conveyor, or another type of intra-facility mechanism. Therefore, while the following exemplary embodiments are primarily related to shipment of freight using airline flights, this will be understood to be illustrative only, and not limiting.

Moreover, cargo management system 4 allows work orders to be developed as action plans for different “levels” of shipment. For example, the work order may detail the loading of goods into a container. Another work order may specify the loading of goods onto a particular flight. Moreover, during the flight, a station manager may create work orders detailing the loading of goods onto other flights and/or the unloading and storage of specific goods within a terminal after their arrival. Thus, work orders are dynamic and exist from an initial planning phase (open status) through completion (complete status), and may be applied throughout the shipment process.

As described in detail herein, cargo management system 4 provides a user interface with which authorized users residing in station office 6 and warehouse 8 interact to perform a number of tasks associated with managing work orders. A user may be, for example, a station manager, warehouse staff, office personnel, space control staff, and the like. Exemplary tasks include printing, viewing, creating, updating, and canceling work orders.

Cargo management system 4 presents the user interface as a graphical set of interrelated screens. The user interface presents the interrelated screens in a manner that allows the user to manage work orders. Users, such as station managers and warehouse managers residing at station office 6, may create, update and cancel work orders detailing the transport of freight throughout an airport station. Other users, such as the warehouse staff residing at warehouse 8, may view and update created work orders.

In general, a user may create work orders by specifying a destination location for each work order and selecting goods for transport to the specified destination location. The selected goods may reside in a number of locations, including goods currently in transit to the station, goods residing in an ULD currently being unloaded, i.e., ULD breakdown, goods currently present at warehouse 8 and the like. The destination location may also include a number of locations, such as an ULD, a terminal container (TCON), a specific terminal location, such as a dangerous materials location, and the like. In this manner, work orders may efficiently detail a wide variety of tasks involving the transport of freight.

The nature of the user interface provided by cargo management system 4 facilitates efficient work order creation for a wide variety of freight transport tasks. In some embodiments, cargo management system 4 provides prioritization of the order to which created work orders are to be executed by the warehouse staff. The prioritization may be performed by a user or automatically by external warehouse systems. This prioritization further increases work order efficiency as the warehouse staff may sequentially execute work orders in order of importance. Cargo management system 4 further incorporates a wider range of available freight allowing the users to schedule via work orders, in advance, freight not currently located at the warehouse.

Each user typically accesses cargo management system 4 via network 9 using a remote computing device having suitable communication software, e.g., a web browser. A user may access cargo management system 4 using a network-enabled computing device, such as a workstation, personal computer, laptop computer, a personal digital assistant (PDA), or a handheld scanning device. The communication device executes communication software, such as a web browser, in order to communicate with cargo management system 4.

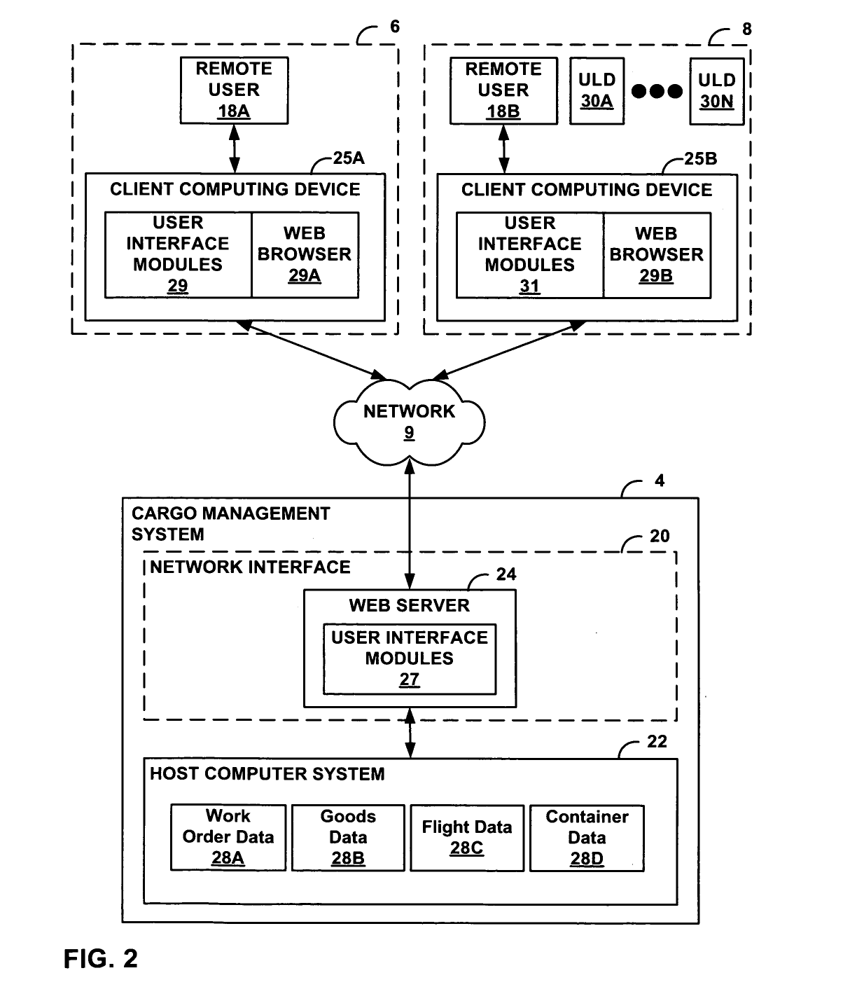

FIG. 2 is a block diagram illustrating an exemplary embodiment of cargo management system 4 in further detail. In the exemplary embodiment, cargo management system 4 includes host computer system 22 coupled to network 9 via network interface 20. In general, host computer system 22 provides a computing platform for hosting shipment management services for logistic service providers. In particular, cargo management system 4 may provide comprehensive logistic services incorporating work order management. Host computer system 22 may comprise, for example, a single Unisys 2200 series mainframe executing logistics management software incorporating work order management software.

Network interface 20 comprises one or more computing services, e.g., web server 24, to provide a seamless, network-based interface by which remote users 18A and 18B access host computer system 22. Although host computer system 22 and web server 24 are illustrated separately in FIG. 2 for exemplary purposes, cargo management system 4 may be realized by a single computing device or a plurality of cooperating computing devices.

Web server 24 provides a web-based interface by which authorized users 18A and 18B communicate with cargo management system 4 via network 9. In one configuration, web server 24 executes web server software, such as software marketed by Microsoft Corporation under the trade designation “INTERNET INFORMATION SERVER.” As such, web server 24 provides an environment for interacting with remote users 18A and 18B via user interface modules 27. As described in detail below, user interface modules 27 provide an interface that allows users 18A and 18B to manage work orders. User interface modules 27 may include Active Server Pages, web pages written in hypertext markup language (HTML) or dynamic HTML, Active X modules, Java scripts, Java Applets, Distributed Component Object Modules (DCOM), and the like. User interface modules 27 may execute within an operating environment provided by web server 24. Alternatively, portions of user interface modules 27 may be downloaded as “client-side” user interface modules 29, 31 that are executed on client computing devices 25A, 25B, respectively. Client-side user interface modules 29, 31 could, for example, include Active X components or Java scripts executed by web browsers 29A, 29B executing on client computing devices 25A, 25B respectively.

User interface modules 27 interact with host computer system 22 to generate, retrieve and update data 28A-28D. For example, user interface modules 27 may generate an exemplary user interface to display work orders associated with a station, a warehouse or even a flight.

For example, user 18A may be remotely located within station office 6, and may view all available work orders associated with warehouse 8, requiring host computer system 22 to access work order data 28A. In viewing the work orders, user 18A may prioritize the work orders for handling by personnel of warehouse 8. Additionally, user 18A may, for example, interact with cargo management system 4 to update one of the viewed work orders. In updating the work order, user 18A may modify a priority that is stored as work order data 28A, goods associated with the work order that is stored as goods data 28B, flights associated with the work order that is stored as flight data 28C and container data stored as container data 28D.

In this manner, user 18A located within station office 6 may update work orders detailing the loading of freight into one or more of ULDs 30A-30N. In addition, user 18A may interact with a number of user interfaces presented by user interface modules 27, as described below, to plan work orders related to planning of flights, planning of specific ULD types, planning of goods at a station, planning of origin bookings at the work order station, and planning of goods on finalized flights to the work order station.

In this example, user 18B represents warehouse personnel remotely located within warehouse 8, and having access to cargo management system 4 to view work orders created by user 18A.

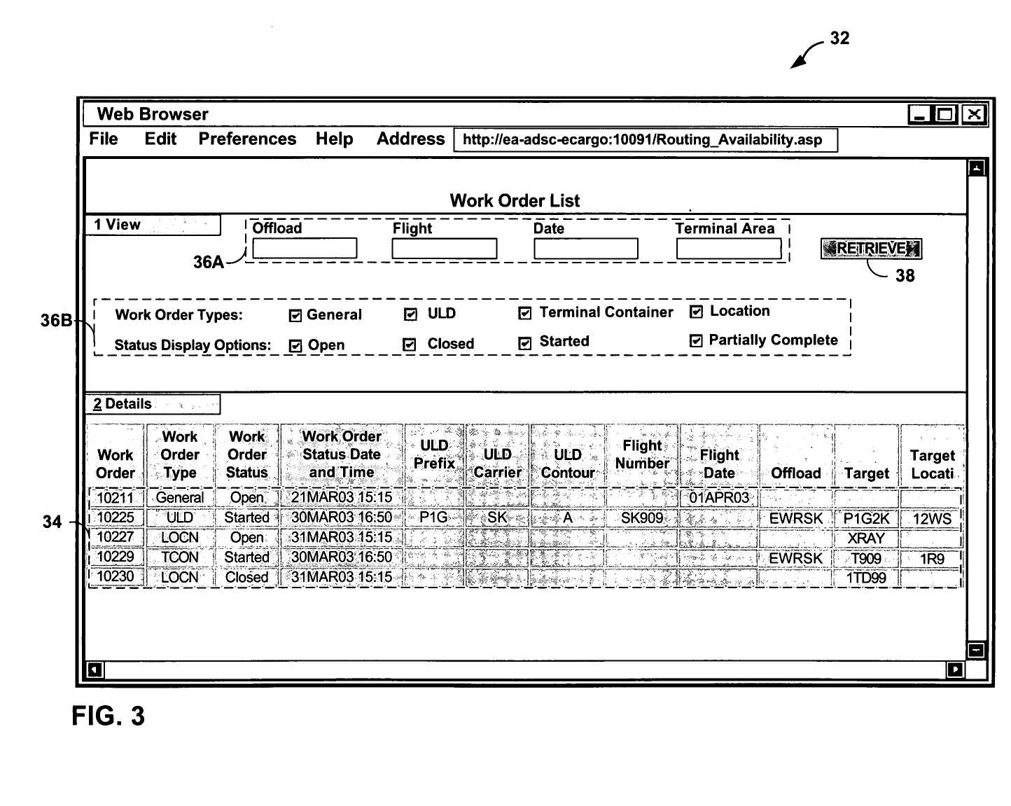

FIG. 3 illustrates an example user interface 32 presented by user interface modules 27 for managing work orders 34. In the illustrated embodiment, user interface 32 provides work order filter selectors 36A and 36B. Work order selectors may comprise, as shown, input fields, as in selectors 36A, check-boxes, as in selectors 36B, pull-down menus and the like. Each one of selectors 36A, 36B allows users 18A, 18B (FIG. 2) to selectively display work orders from their remote locations. For example, user 18A may display work orders detailing the packing of freight into ULDs by activating the check box, as shown in FIG. 3, next to the ULD selector included within work order selectors 36B. Upon activating one or more of selectors 36A, 36B, user 18A selects retrieve input 38.

Based on the state of selectors 36A, 36B when user 18 selects retrieve input 38, user interface 32 presents work orders that satisfy the state of selectors 36A, 36B. As shown in the illustrated embodiment, user 18A selects work orders of type general, ULD, terminal containers and location, as well as work orders with display options open, closed, started and partially complete via work order selectors 36B. In this example, user 18A has not activated any of work order selectors 36A and in leaving them inactivated, work order selectors 36A do not factor in to displaying work orders 34. The resulting work orders, work orders 34, appear after user 18 selects retrieve input 38.

Work orders 34 may include information regarding a type of the work order, a status of the work order, a work order status date and time, a ULD prefix, a ULD carrier, a ULD contour, a flight number, a flight date, an offload point, a target, a target location and the like. In one embodiment, a target may be a ULD, a terminal container, or a location. In another embodiment, the target may be any facility, container, vessel or location for receiving goods, or to which goods may be moved. Selectors 36A, 36B correspond to the work order information and serve to filter work orders that do not satisfy the state of selectors 36A, 36B. Thus, it will be understood selectors 36A, 36B are merely exemplary, and could include any of the information types included in work orders instead of, or in addition to, the selectors shown in FIG. 3. User 18A specifies the state of selectors 36A, 36B in order to limit the number of work orders displayed. Work orders 34 thus, represent a subset of the available work orders, allowing user 18A to more easily select work orders tailored to the needs of user 18A. In this manner, user 18A may more efficiently select pertinent work orders.

Upon receiving the state of selectors 36A, 36B, web server 24 interacts with host computer system 22 in order to retrieve work orders that satisfy the state of selectors 36A, 36B. Host computer system 22 may access relevant work order data 28A in order to determine work orders 34. Host computer system 22 returns the relevant work order data to web server 24. Web server 24 formats the relevant work order data for display within user interface 32 as work orders 34.

Both users 18A and 18B may remotely access cargo management system 4 and, via separate interfaces, select one of work orders 34 to perform further actions on the selected one of work orders 34. As described above, user 18A, a station or warehouse manager residing in station office 6, may select one of work orders 34 to view, update or cancel the selected work order. User 18B, a warehouse staff personnel residing within warehouse 8, may select one of work orders 34 to view or update the selected work order.

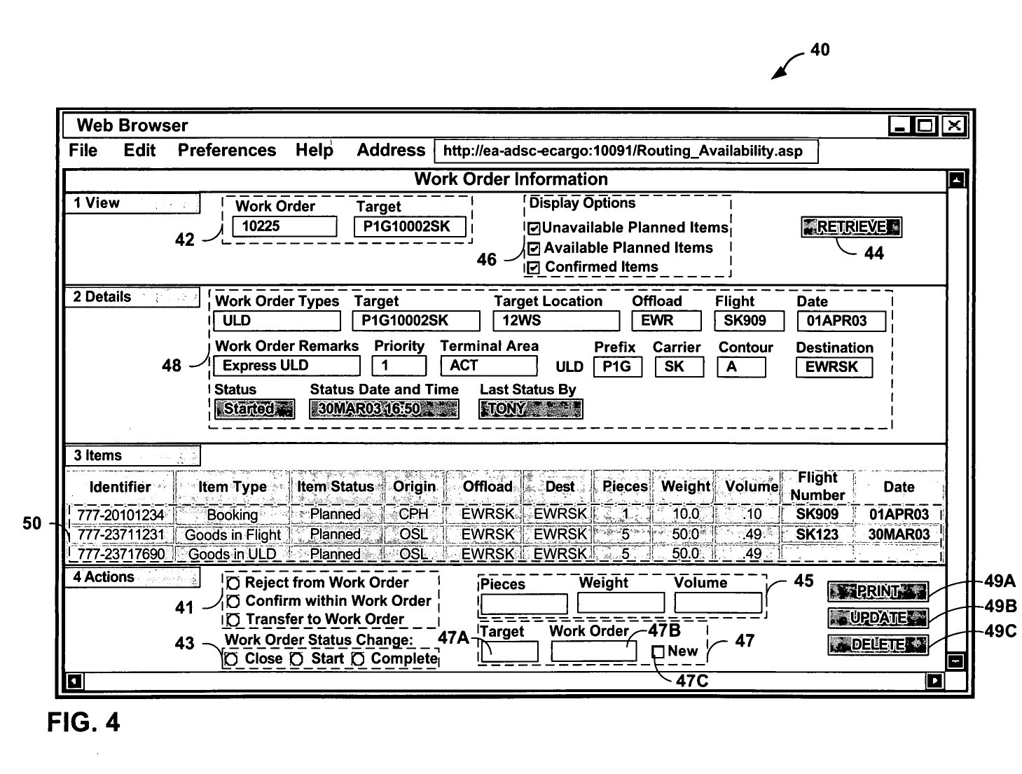

FIG. 4 illustrates an exemplary user interface 40 to display detailed work order information. In particular, user interface modules 27 generate user interface 40 in response to the selection of one of work orders 34 (FIG. 3). In this example, the remote user has selected work order number 10225. User interface 40, similar to user interface 32, presents work order selectors 42 and retrieve input 44. User interface 40 further presents goods selectors 46. In some instances, user interface 40 may initially display work order selectors 42 with data entered into the input fields of work order selectors 42 based on which one of work orders 34 is selected. User 18A or 18B may activate one or more of goods selectors 46 prior to selecting retrieves input 44 in order to selectively display one or more goods associated with the work order specified by work order selectors 42.

Upon selection of retrieve input 44, user interface 40 may display work order information 48. Work order information 48 may also be displayed with data specific to the work order selected from work orders 34. Thus, upon selection of one of work orders 34, users 18A, 18B may immediately view work order information 48. Work order information 48 may include work order data previously displayed in user interface 32 as well as further work order information such as a priority, a work order remark, a “last status by” field and other such detailed work order information.

Since work orders detail the transport of goods, user interface 40 includes goods 50 that are associated with the work order specified by work order selectors 42. User interface 40 displays goods 50 in accordance with goods selectors 46. For example, all of goods selectors 46 are activated indicating that goods 50 contain all available goods that correspond to a status of unavailable planned items, available planned items and confirmed items. Goods 50 satisfy the state of goods selector 46, however in the example of FIG. 4 goods 50 do not include any goods having the status of confirmed items. In the event, goods having a status of available planned items are confirmed these confirmed goods would appear within goods 50. As will be described in more detail below, users 18A, 18B may alter the status of goods 50 during the course of transporting the goods to the location specified by the work order.

Again, web server 24 receives the states of work order selectors 42 and goods selectors 46. Web server 24 interacts, as described above, with host computer system 22 to gather goods data from goods data 28B that satisfies the state of selectors 42, 46. Web server 24 formats the goods data in order to present goods 50 within user interface 40. Goods data includes an identifier, an item type, an item status, an origin, an offload point, a destination location, a number of pieces, a weight, a volume, a flight number, a flight date and other such data related to goods and goods shipment.

The remote user, such as user 18A or user 18B, interacts with user interface 40 to view detailed data associated with a specific work order. User 18A may, for example, make use of this data to determine which freight items are currently included within the specific work order. Using this data, user 18A may tailor the work order to meet the needs of specific goods. For example, user 18A may create a work order to specify transportation of goods that require delivery prior to a specific date.

User 18B, however, may access the detailed data to view the status of various goods associated with the work order in order to execute the work order. In particular, user 18B working within warehouse 8 may view a work order, such as work order number 10225, while executing the details of the work order. User 18B may also select one or more of goods 50 to perform an action upon. User interface 40 presents a variety of actions that user 18B may perform on a selected good as well as the status of the work order. These actions are each associated with one or more inputs, which include goods action inputs 41, work order status inputs 43, goods update inputs 45, and work order update inputs 47. One or more of these inputs may function together allowing cargo management system 4 to provide a variety of complex actions.

User 18B may interact with user interface 40 to update a status of a work order throughout the course of executing the work order. Initially, a work order is open. Once user 18A has completed the planning of the work order, user 18A may set the status to “close”. Once the warehouse staff begins executing the work order, user 18B may set the status to “start.” Upon finishing the execution of a work order, the status becomes complete. The status may be set to “start” manually by user 18B or automatically. Moreover, the status may be set to “complete” status manually using work order status inputs 43 or automatically, e.g., close ULD or last confirm. User 18B may set work order status input 43 manually to indicate a start status. The start station may also, in some embodiments, automatically be set to “start” upon updating or printing the work order. Users 18A and 18B interact with user interface 40 to specify these statuses via work order status inputs 43.

User 18B may select input “Confirm within Work Order” of goods action inputs 41. To confirm a shipment indicates that the warehouse staff has successfully transported the shipment to the location. In some embodiments, items, such as goods and containers, of a work order may be automatically confirmed by cargo management system 4 via basic user interface functions, such as updating the status of a good as described above. During the course of executing, user 18B and other warehouse staff may encounter a number of problems. To avoid these problems, user interface 40 provides goods action inputs 41 that may manage adverse situations allowing the work order to adapt to the needs of the warehouse staff. User 18B may, for example, select one of goods 50 and subsequently select the first input of goods action inputs 41, which is “Reject from Work Order.” User 18B may reject one or more of goods 50 due to airline restrictions prohibiting the good from being shipped. User 18B may also select the “Transfer to Work Order” input of goods action inputs 41. This input along with additional input entered into work order action inputs 47 may transfer the selected goods to a different work order as specified by work order action inputs 47.

Work order action inputs 47 include input fields 47A, 47B and new input 47C. User 18B may enter a target (e.g., a ULD, a terminal or other container, or a location), a work order number or both into input fields 47A, 47B respectively. In the event that user 18B wishes to transfer the selected goods to a new work order, user 18B may activate new input 47C to indicate that the target entered into input field 47A specifies a new work order. In this manner, user 18B may efficiently transfer goods to a newly created work order. User 18B may instead transfer goods to an existing work order by specifying a target, work order or both in input fields 47A, 47B, respectively. Actions performed by user 18B and discussed herein in reference to user 18B may also be performed and discussed in the context of user 18A. However for ease of illustration, the actions are discussed explicitly in the context of user 18B.

Host computer system 22 in response to the creation of a new work order updates work order data 28A to include the new work order. Furthermore, host computer system 22 links the newly created work order data within work order data 28A to the selected goods within goods data 28B. In the event, that a good is assigned to an existing work order, host computer system 22 simply links the existing work order data within work order data 28A to selected goods data of good data 28B. Host computer 22 may link other types of data including flight data 28C and container data 28D to work order data 28A to build a comprehensive work order detailing various locations, goods, flights, containers and other such work order related data.

In some embodiments, user interface 40 may provide search functionality so that user 18A may search for current work orders. In providing this functionality, user 18A may not need to recall work order numbers or targets which may lead to more efficient operation of user interface 40 by user 18A.

Additional issues may arise during the executing of a work order. For example, data corresponding to a particular good may be incorrect. In some instances, this may adversely affect the work order especially in situations requiring the loading of volume-limited containers. User 18B may alter the incorrect data associated with one or more of goods 50 to correct this problem. By selecting one or more of goods 50, user 18B may specify new data to accurately reflect the selected good's number of pieces, weight and volume within goods update inputs 45.

Upon entering data into the available inputs listed above, user 18B may select any one of action inputs 49A-49C. Action input 49A may print a paper document comprising the details of the work order. User 18B may then reference the paper document during the course of executing the work order. Action input 49B performs the update to the selected goods. The update depends in part on the state of each of inputs 41-47 and may perform the action discussed above as well as other of a similar nature. Finally, action input 49C allows a user to delete the work order entirely.

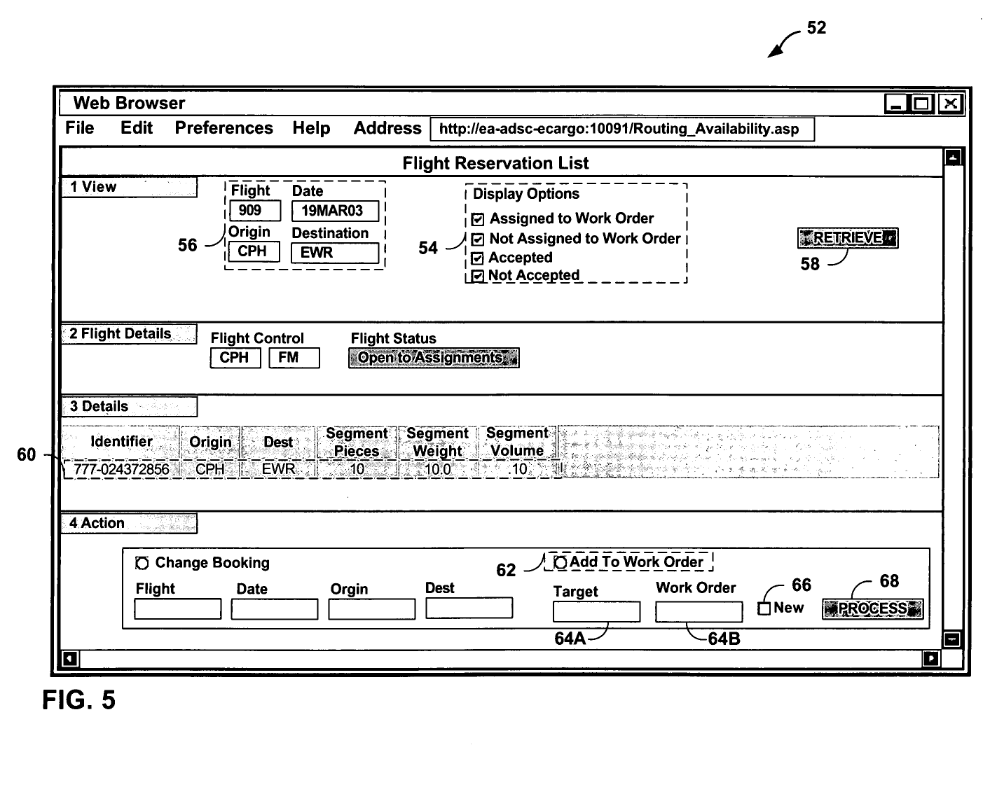

FIG. 5 is an example user interface 52 that illustrates the addition of booked shipments to a work order. In particular, user interface 52 allows user 18A to search a flight reservation list for a flight having booked shipments that satisfy booked shipments selectors 54. By entering flight data into flight selectors 56, selecting one or more of booked shipments selectors 54 and selecting retrieve input 58, user 18A may view shipments 60 in accordance with the state of selectors 54 and 56. User 18A may select one or more of shipments 60 and further specify an action to be performed on the one or more selected shipments. Specifically, user 18A may add one or more of shipments 60 to a work order.

As described above, host computer system 22 utilizes the state of selectors 54, 56 to determine shipments 60 from goods data 28B. For example, the state of flight selectors 56 specifies a flight 909 scheduled to leave Mar. 19, 2003 from airport code CPH and arrive at destination airport code EWR. Host computer 22 may access flight data 28C and determine a flight in accordance with the state of flight selectors 54. Upon determining a flight, host computer system 22 may then determine shipments booked to the flight from goods data 28B. Further, host computer system 22 may only select shipments containing goods from goods data 28B that satisfy booked shipments selectors 54. Booked shipments selectors 54, as shown in FIG. 5, specify that host computer system 22 should gather shipments that are assigned to a work order, not assigned to a work order, accepted and not accepted. Accepted goods refer to booked shipments that the airline has accepted and not accepted shipments are booked shipments not yet accepted by the airline.

User 18A may, for example, select one or more of shipments 60 and add the selected shipments to a work order. The addition of shipments to a work order is similar to the transfer of shipments to a work order, as described above. Selecting action input 62 enables user 18A to enter a target (e.g., ULD, terminal container, or location), a work order number or both into input fields 64A and 64B, respectively. In the event that user 18A needs to add the selected shipments to a new work order, user 18A may activate new input 66 to indicate that the target entered into input field 64A specifies a new work order. User 18A selects process input 68 to finalize the addition of the selected shipments to an existing or newly created work order. In this manner, user 18A may efficiently create a work order that includes shipments not assigned to a work order and not accepted by the airline. Moreover, user 18A may add shipments to existing work orders by specifying a target, work order or both in input fields 64A, 64B or both 64A and 64B, respectively.

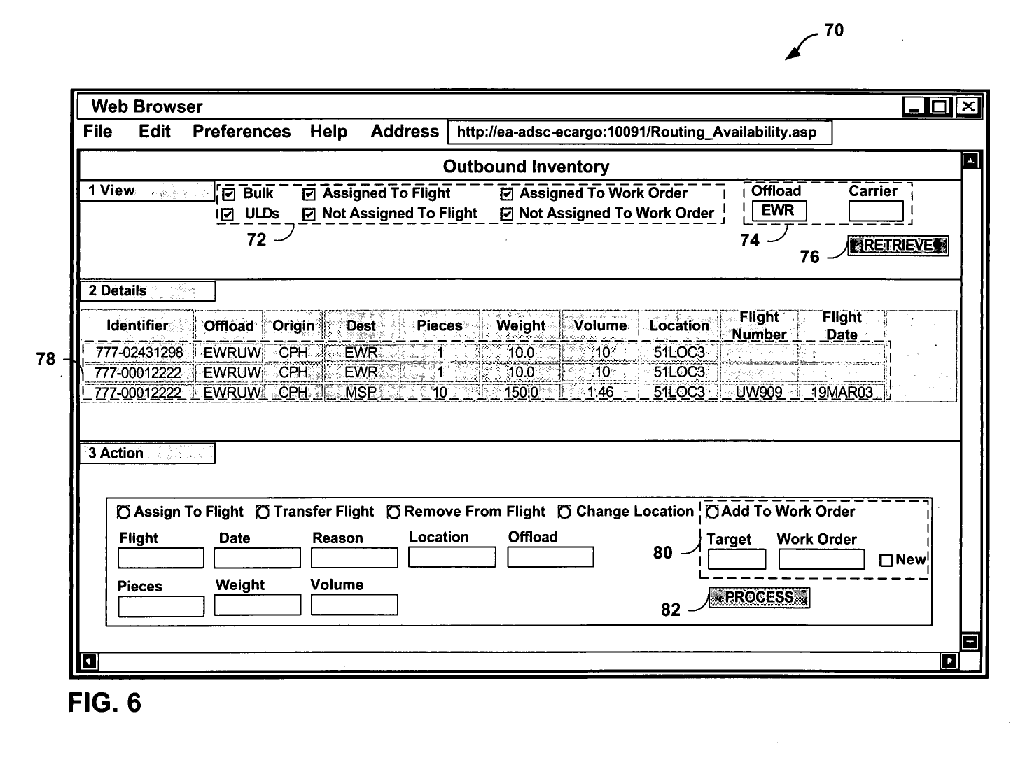

FIG. 6 is an example user interface 70 illustrating the addition of outbound inventory to a work order grouped by their offload station which in this case is an airport. In another embodiment, this may be another transportation facility such as a bus or train station, or trucking terminal, a dock location within a harbor, etc. User 18A may specify which goods to display using selectors 72, 74 as described above. Upon selecting retrieve input 76, user interface 70 displays goods 78 in accordance with the state of selectors 72, 74. Goods 78 may include goods not currently assigned to a flight, goods assigned to a flight, goods assigned to a work order, goods not assigned to a work order, and the like.

User 18A may select one or more of goods 78 and assign the selected goods to a work order. Similar to the addition of goods to a work order as described in reference to FIG. 5, user 18A may add the selected goods to a work order using the inputs of region 80. User 18A then selects process input 82 to finalize the creation or update to a work order specified in region 80.

User input 70 presents another location from which goods can be assigned to a work order. As will be described in more detail below, cargo management system 4 offers many user interfaces that specify locations from which a user may specify the transport of goods. Such locations may include locations outside of the warehouse, locations in transit to the station, such as an airplane, and the like. Moreover, pending goods may be added to a work order, such as goods arriving on inbound flights, goods currently undergoing ULD breakdown, and the like. Thus, cargo management system 4 presents a more comprehensive approach to managing work orders by including a large number of locations and goods.

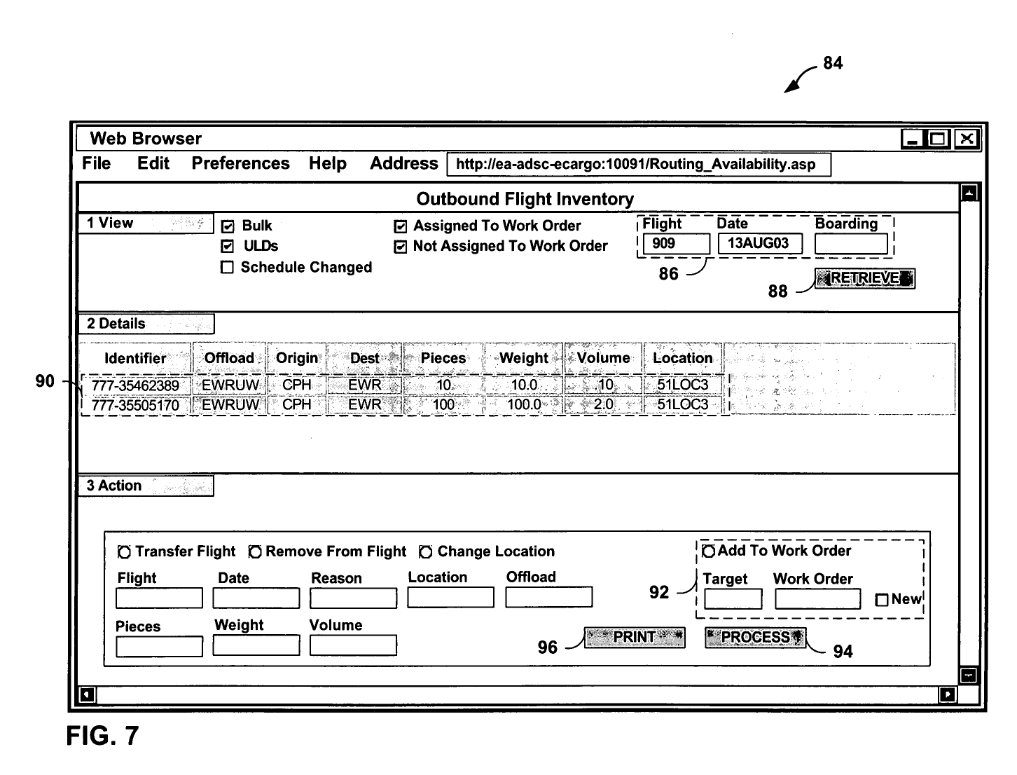

FIG. 7 is an example user interface 84 illustrating the addition of booked or flight assigned goods to a work order grouped by a given flight. User 18A selects the flight by indicating a flight number, a date, and optionally a boarding station, into flight selector 86. Upon selecting retrieve input 88, user interface 84 presents booked and flight assigned goods 90 for transport on the indicated flight.

User 18A may select one or more of goods 90 for addition to an existing or newly created work order. As discussed above, user 18A may add the selected goods to the work order using the inputs within region 92 and process input 94. User 18A may additionally print one or more of goods 90 by selecting print input 96. Furthermore, user 18B may also print one or more of goods 90. User 18B may use the printed copy of one or more of goods 90 to aid in transporting the desired goods to the correct location.

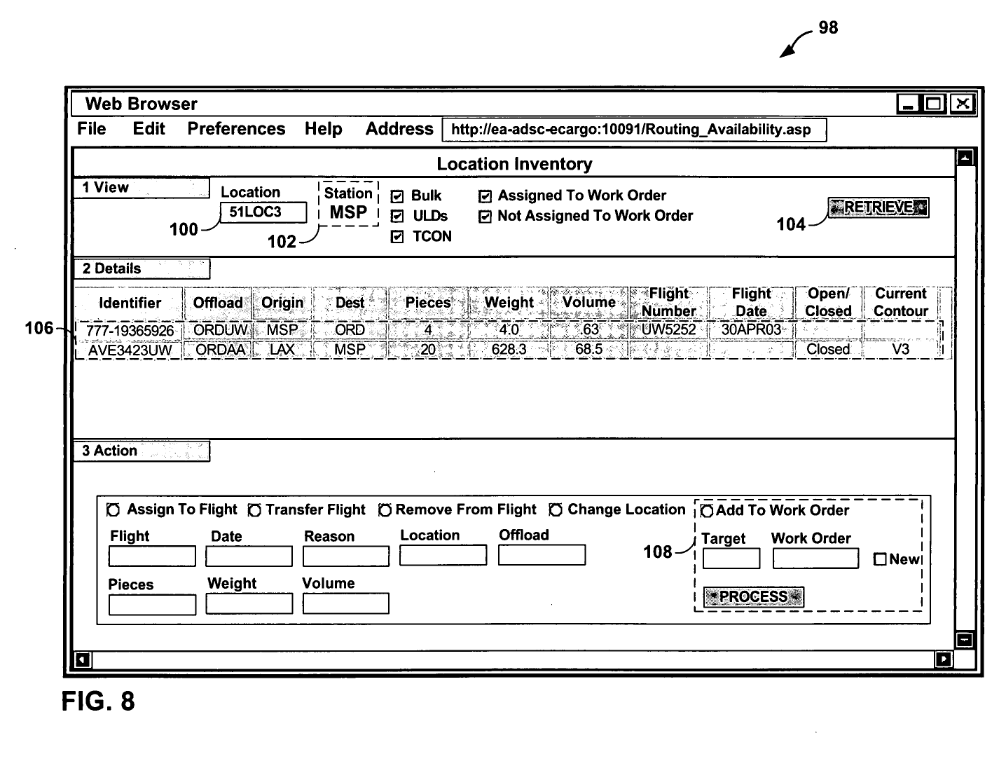

FIG. 8 is an example user interface 98 illustrating the addition of goods located at a location in warehouse 8 to a work order grouped by current warehouse location. User 18A may specify the location in input field 100. As shown, user 18A enters a location code “51LOC3” into input filed 100. User interface 98 also displays the current station, however user interface 98 does not allow user 18A to change the station. A station manager is generally responsible for a single station, and thus, a station manager, such as user 18A, may only define work orders for the proximity of the station user 18A manages. User interface 98 may further present search functionality allowing user 18A to search for location codes.

Upon entering the location code into input field 100 and activating any other options, user 18A selects retrieve input 104. User interface 104 in response to the selection of retrieve input 104 displays goods 106 located at the specified location. User 18A may select one or more of goods 106 for addition to a work order. User 18A uses inputs within region 108 to assign the selected goods to the work order specified within region 108.

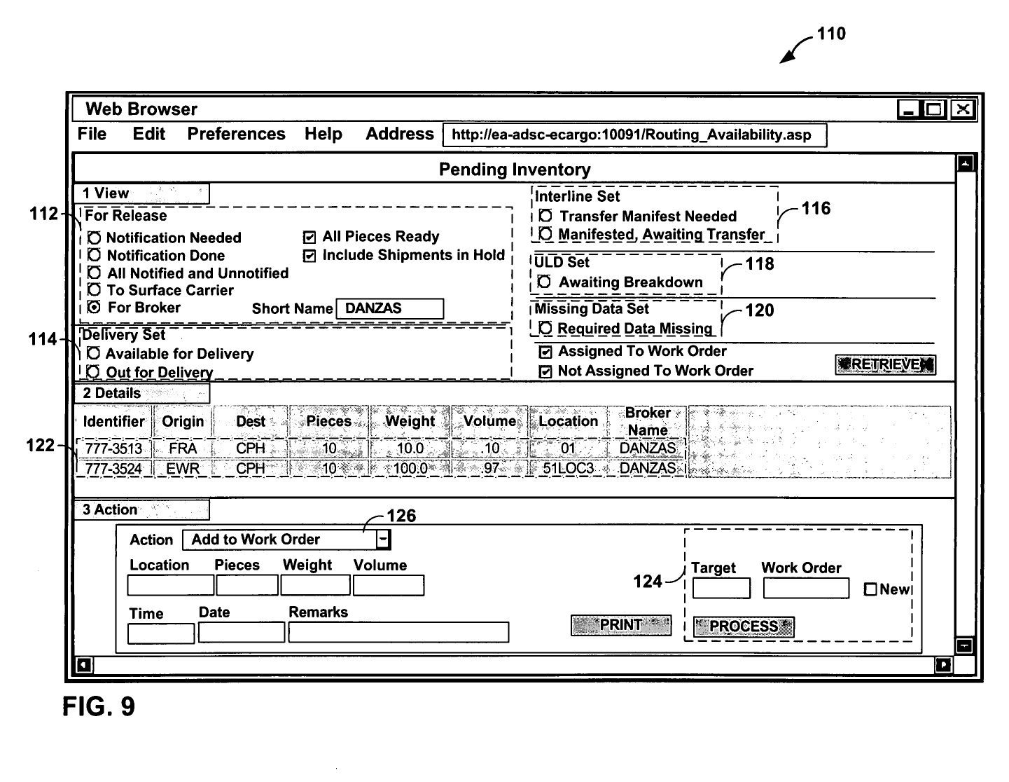

FIG. 9 is an example user interface 110 illustrating the addition of goods pending import processing at a station to a work order. User interface 110 presents a number of selectors to define pending goods including for release selectors 112, delivery set selectors 114, interline set selectors 116, ULD set selectors 118, missing data set selectors 120, and the like.

User 18A may utilize for release selectors 112 for defining goods that require notification or that have notification done as well as goods with a surface carrier or broker. Delivery set selectors 114 define goods available for delivery or goods out for delivery. Interline set selectors 116 define goods that require a transfer manifest or goods that have a manifest and are awaiting transfer. ULD set selectors 118 define goods that are awaiting breakdown of the ULD. Missing data set selectors 120 define goods having missing data. User 18A may check each set of goods corresponding to the selections made with pending good selectors 112-120 to determine goods in certain conditions. User 18A, in the illustrated embodiment, uses for release selectors 112 to define goods assigned to a broker “DANZAS.”

User interface 110 displays goods 122 in response to the selection made by user 18A. User 18A may select one of goods 122 and add the goods to a work order using region 124 as well as action input 126. User 18A may, for example, create a work order detailing the transport of goods from their indicated location as shown in goods 122 to a broker specific location. In the illustrated embodiment, user 18A may move goods 122 to the location that is specified by the DANZAS broker. In this manner, cargo management system 4 provides for the transport of goods to and from a variety of locations and is not limited strictly to transporting goods currently available in the warehouse to ULDs.

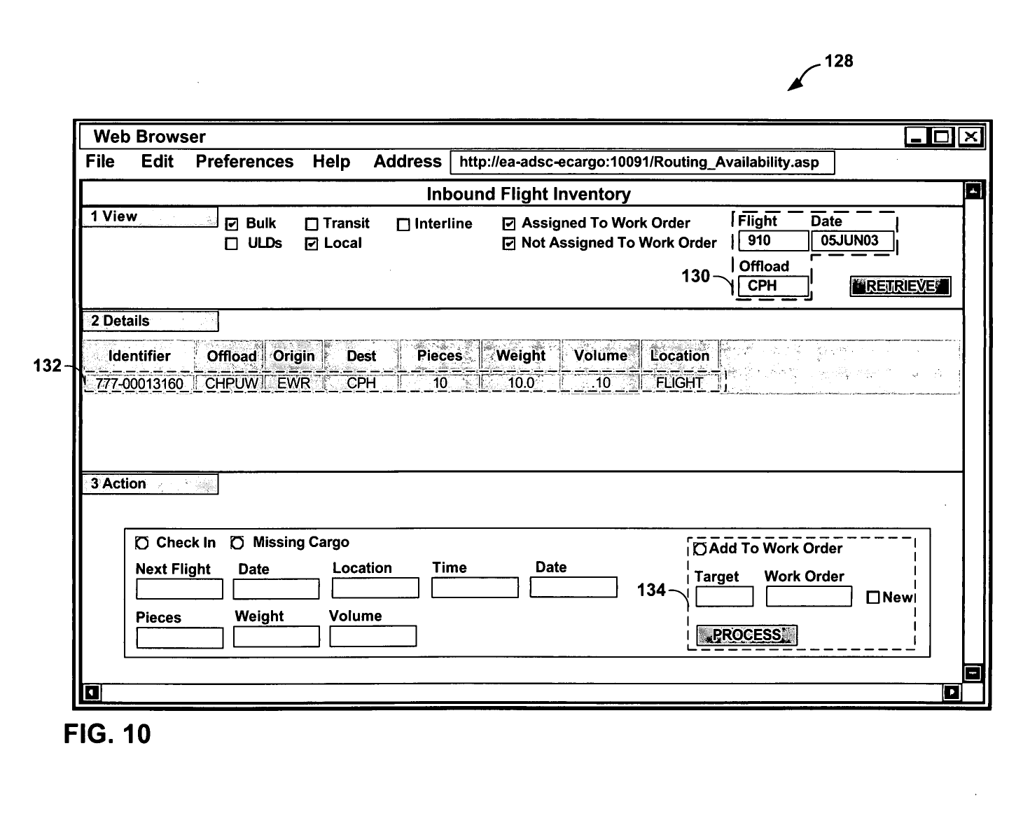

FIG. 10 is an example user interface 128 illustrating an addition to a work order of goods arriving on inbound flights to a station. User 18A may select an inbound flight by specifying a flight number, a flight date, and optionally an offload point using inbound flight selectors 130 included within user interface 128. After determining the appropriate inbound flight, user interface 128 displays inbound goods 132. Next, user 18A may select inbound goods 132 and perform the addition of inbound goods 132 to a work order as specified in region 134.

Cargo management system 4 presents user interface 128 to allow user 18A the ability to create a work order detailing the transportation of inbound goods. User 18A may specify, for example, a storage location within the warehouse where the inbound goods should be stored upon arrival. Additionally, user 18A may determine high priority goods that require immediate attention prior to arrival in the station and efficiently handle these goods within the details of a work order.

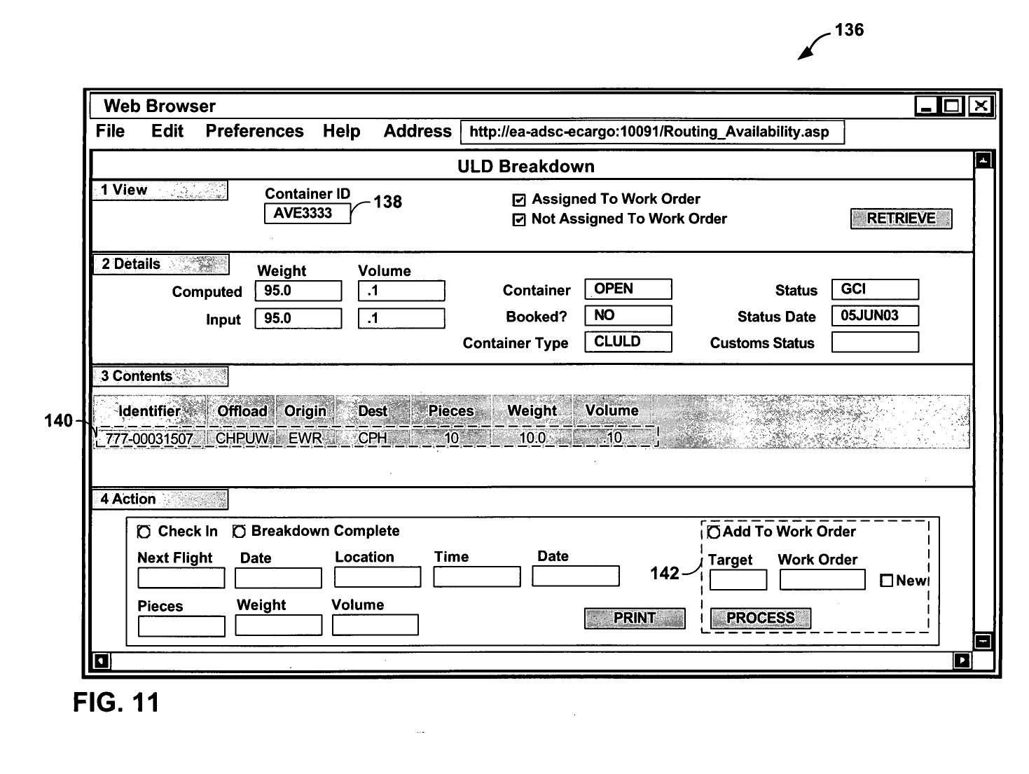

FIG. 11 is an example user interface 136 illustrating an addition to a work order of goods that are undergoing a breakdown process. User interface 136 includes an input field 138 that allows user 18A to specify a container identifier (shown in FIG. 11 as “Container ID”). Upon submitting the container identifier, host computer system 22 accesses container data 28D to determine which goods are present in the container. User interface 136 then presents these goods as breakdown goods 140.

Breakdown goods 140 may be included in a work order to schedule transport of breakdown goods 140 to a destination location. Breakdown goods having a destination location at the station may further be included in a work order detailing the transport of the breakdown goods to a storage location, for example. User 18A, as in previous FIGS. 5-10 may add breakdown goods 140 to a work order using region 142.

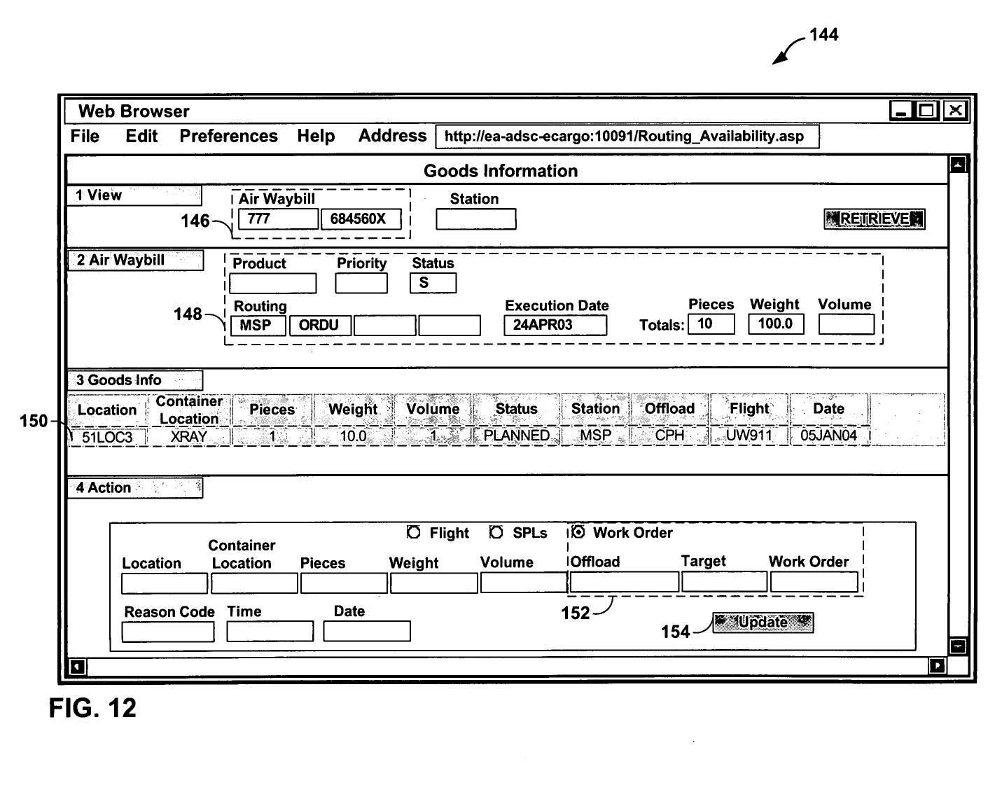

FIG. 12 is an example user interface 144 illustrating the update of a work order for a particular air waybill. User 18A may select an air waybill by specifying the air waybill identifier within input fields 146. User interface 144 presents detailed data of the specified air waybill within the input fields of region 148. Furthermore, user interface 144 presents goods associated with the specified air waybill, as shown by goods 150. User 18A may select goods 150 for addition to a work order by specifying the work order within the input fields of region 152. User 18A finalizes the update to the specified air waybill by selecting update input 154.

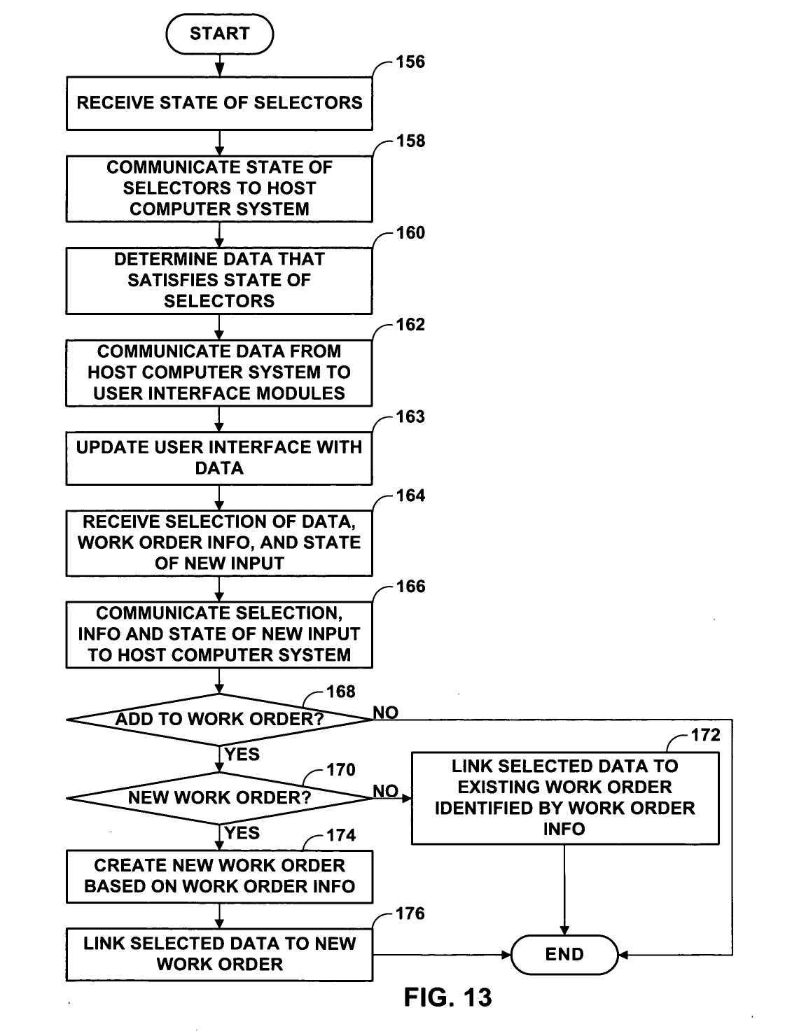

FIG. 13 is a flowchart illustrating example operation of host computer system 22 to manage the addition of goods to a work order. Initially, one of user interfaces 27 receives the state of selectors, such as booked shipment selectors 54 (FIG. 5) and flight selectors 56 (156). User interface 52 communicates the state of the selectors to host computer system 22 (158). The state of the selectors may include text as in the case of flight selectors 56, active and inactive states as is the case of booked shipment selectors 54, and other such inputs resulting from check boxes, buttons, pull-down menus and the like.

Host computer system 22 accesses data 28 to determine work orders, goods, flights and containers from respective work order data 28A, goods data 28B, flight data 28C and container data 28D. Host computer system 22 may maintain further data related to work orders such as station data, booking data, terminal location data and the like. Host computer system 22 accesses data 28 to determine data that satisfies the state of selectors 54, 56 (160). For example, the selectors may specify a requirement for goods already assigned to a work order. In response, host computer system 22 may access goods data 28 to determine which goods are already assigned to a work order. Next, host computer system 22 communicates the determined data to user interface 52 (163).

Upon receiving the data, user interface modules 27 updates user interface 52 by including the determined data, i.e., booked shipment 60, within user interface 52 (164). User interface 52 may then accept selection of one or more booked shipments 60 and action input 62. Upon receiving the selection of one or more of booked shipments 60 and the state of action input 62, input fields 64A, 64B and new input 66 (the state of action input 62, and input fields 64A, 64B are referred to in FIG. 13 as “work order info”) (164), user interface 52 communicates this information to host computer system 22 (166).

Host computer system 22 processes the selection of one or more of booked shipments 60, the work order info, and the state of the new input. Host computer system 22 analyzes the state of action input 62. The state of action input 62 determines whether the selection is to be added to a work order of work order data 28A (168). In the event that the state of action input 62 is inactive, then host computer system 22 performs no operation concerning work orders. If the state, however, is active, then host computer system 22 analyzes the state of new input 66. The state of new input 66 determines whether host computer system 22 should create a new work order (170). In the event that the state of new input 66 is inactive, host computer system 22 accesses input fields 64A, 64B to determine an existing work order. Upon determining the existing work order, host computer system 22 links the selected data to the determined work order data of work order data 28A (172). If the state of new input 66 is active, host computer system 22 creates a new work order within work order data 28A using the states of input fields 64A, 64B in creating the new work order (174). Host computer system 22 links the selected data to the new work order, as described above (176).

Various embodiments of the invention have been described. These and other embodiments are within the scope of the following claims.

1. A cargo management system comprising:
a host computer system that includes a processor executing software to perform work order management tasks that maintain data associated with a work order, wherein the work order specifies a destination location; and
a user interface module that presents a user interface for access to the host computer system, wherein the user interface includes at least one input mechanism for specifying within the work order transfer of one or more goods undergoing one or more processes to the destination location, wherein the goods undergoing one or more processes includes one or more of the one or more goods being currently in transit to a warehouse,
wherein the at least one input mechanism includes an input mechanism for selecting at least one of the one or more goods that are in transit to the warehouse, and
wherein the work order comprises a general-purpose planning vehicle by which a station office directs warehouse personnel at the warehouse regarding the transfer of the one or more goods.

2. The cargo management system of claim 1, wherein at least one input mechanism includes work order update inputs for transferring one or more goods from the work order to a different work order, and the host computer system automatically links data associated with the goods to data associated with the different work order.

3. The cargo management system of claim 2, wherein a different work order comprises a newly created work order, and wherein work order update inputs comprise a new input and the host computer system creates the newly created work order when the new input is activated.

4. The cargo management system of claim 1, wherein at least one input mechanism includes a good action input for altering statuses of the one or more goods specified within the work order, and the host computer system alters good data associated with the one or more goods in response to the good action input.

5. The cargo management system of claim 4, wherein statuses of the one or more goods include one of a rejected status, a confirmed status, and a planned status.

6. The cargo management system of claim 1, wherein at least one input mechanism includes a work order status input for altering a status of the work order and the host computer system alters the data associated with the work order in response to the work order status input.

7. The cargo management system of claim 6, wherein the host computer system automatically updates the status of the work order.

8. The cargo management system of claim 6, wherein the status of the work order includes one of an open status, a closed status, a started status, a partially completed status, and a completed status.

9. The cargo management system of claim 1, wherein at least one input mechanism includes good update inputs for updating data associated with the one or more goods, wherein the data associated with the one or more goods includes data defining a number of pieces, a weight, and a volume.

10. The cargo management system of claim 1, wherein the host computer system further prioritizes the work order with respect to other available work orders.

11. The cargo management system of claim 1, wherein the destination location comprises one of a terminal container, a terminal location, the warehouse, and a unit load device.

12. The cargo management system of claim 1, wherein one or more goods undergoing one or more processes include one or more of the one or more goods being unloaded from a container and still being pending.

13. The cargo management system of claim 1, wherein at least one input mechanism includes one of a button, a check box, and a pull-down menu.

14. A processor-based method comprising:
presenting, with a processor, a user interface to include at least one input mechanism for specifying within a work order the transfer of one or more goods undergoing one or more processes to a destination location;
processing, with the processor, the at least one input mechanism received from the user interface to generate a work order, wherein the work order details transfer of the one or more goods undergoing one or more processes to the destination location, wherein the goods undergoing one or more processes includes one or more of the one or more goods being currently in transit to a warehouse,
wherein the at least one input mechanism includes an input mechanism for selecting at least one of the one or more goods that are in transit to the warehouse, and
wherein the work order comprises a general-purpose planning vehicle by which a station office directs warehouse personnel at the warehouse regarding the transfer of the one or more goods.

15. The processor-based method of claim 14, wherein at least one input mechanism includes work order update inputs for transferring one or more goods from the work order to a different work order, and processing the at least one input mechanism includes automatically linking data associated with the goods to data associated with the different work order in response to the work order update inputs.

16. The processor-based method of claim 15, wherein the different work order comprises a newly created work order, and wherein work order update inputs comprise a new input and processing the at least one input mechanism further includes creating the newly created work order when the new input is activated.

17. The processor-based method of claim 14, wherein at least one input mechanism includes a good action input for altering statuses of the one or more goods specified within the work order, and processing the at least one input mechanism comprises altering good data associated with the one or more goods in response to the good action input.

18. The processor-based method of claim 17, wherein statuses of the one or more goods include one of a rejected status, a confirmed status, and a planned status.

19. The processor-based method of claim 14, wherein at least one input mechanism includes a work order status input for altering a status of the work order and processing the at least one input mechanism includes altering the data associated with the work order in response to the work order status input.

20. The processor-based method of claim 19, wherein altering a status of the data associated with the work order occurs automatically.

21. The processor-based method of claim 19, wherein the status of the work order includes one of an open status, a closed status, a started status, a partially completed status, and a completed status.

22. The processor-based method of claim 14, further comprising prioritizing the work order with respect to other available work orders.

23. The processor-based method of claim 14, wherein at least one input mechanism includes good update inputs for updating data associated with the one or more goods, wherein the data associated with the one or more goods includes data defining a number of pieces, a weight, and a volume, and processing the at least one input mechanism includes updating the data associated with the one or more goods.

24. The processor-based method of claim 14, wherein the destination location comprises one of a terminal container, a terminal location, the warehouse, and a unit load device.

25. The processor-based method of claim 14, wherein one or more goods undergoing one or more processes include one or more of one or more goods being unloaded from a container and one or more goods being still pending.

26. The processor-based method of claim 14, wherein at least one input mechanism includes one of a button, a check box, and a pull-down menu.

27. A cargo management system comprising:
a work order data storage means for storing data associated with a work order, wherein the data associated with a work order specifies a destination location;
a goods data storage means for storing data associated with one or more goods undergoing one or more processes;
a computing means for linking the data associated with one or more goods to the data associated with the work order; and
a user interfacing means for presenting a user interface that includes at least one input mechanism, wherein the computing means links the data associated with the one or more goods to the data associated with the work order based on the at least one input mechanism, wherein the goods undergoing one or more processes includes one or more of the one or more goods being currently in transit to a warehouse,
wherein the at least one input mechanism includes an input mechanism for selecting at least one of the one or more goods that are in transit to the warehouse, and
wherein the work order comprises a general-purpose planning vehicle by which a station office directs warehouse personnel at the warehouse regarding the transfer of the one or more goods.

28. (canceled)

29. The cargo management system of claim 27, wherein the specified destination location comprises one of a terminal container, a terminal location, the warehouse, and a unit load device.

30. The cargo management system of claim 27, wherein one or more goods undergoing one or more processes include one or more of one or more goods being unloaded from a container and being still pending.

31. The cargo management system of claim 27, wherein a computing means includes a prioritization means for prioritizing data associated with the work order with respect to data associated with other available work orders.
